(19) United States
(12) Patent Application Publication
(10) Pub. No.: US 2025/0306993 A1
(43) Pub. Date: Oct. 2, 2025

(54) METHOD FOR DISTRIBUTED OPERATION BASED ON NEURAL NETWORK MODEL AND RELATED APPARATUS

(71) Applicant: Beijing Baidu Netcom Science Technology Co., Ltd., Beijing (CN)

(72) Inventors: Xiang Gao, Beijing (CN); Jiabin Yang, Beijing (CN); Qiuliang Chen, Beijing (CN); Dianhai Yu, Beijing (CN); Yanjun Ma, Beijing (CN); Haifeng Wang, Beijing (CN)

(21) Appl. No.: 19/238,989

(22) Filed: Jun. 16, 2025

(30) Foreign Application Priority Data
Mar. 11, 2025 (CN) 202510287483.6

(51) Int. Cl. G06F 9/48; G06N 3/082

(52) U.S. Cl. CPC G06F 9/4881; G06N 3/082

(57) ABSTRACT

A method for distributed operation based on a neural network model and a related apparatus are provided, relating to the field of computer technology and in particular to the fields of artificial intelligence, deep learning, machine learning, distributed training and other technologies. The method includes: parsing code of the neural network model to construct an operator topology graph corresponding to the neural network model; generating a distributed operation strategy of the neural network model based on the operator topology graph and a preset resource constraint; and modifying the code of the neural network model based on the distributed operation strategy to obtain target code; where the target code is used to operate the neural network model based on the distributed operation strategy on a computing device corresponding to the resource constraint.

### CROSS-REFERENCE TO RELATED APPLICATIONS

The present application claims priority to Chinese Patent Application No. CN202510287483.6, filed with the China National Intellectual Property Administration on Mar. 11, 2025, the disclosure of which is hereby incorporated herein by reference in its entirety.

### TECHNICAL FIELD

The present disclosure relates to the field of computer technology, and in particular to the fields of artificial intelligence, deep learning, machine learning, distributed training and other technologies.

### BACKGROUND

In recent years, the artificial intelligence technology has made remarkable progress, mainly due to the widespread adoption of large-scale neural networks and large data sets. At the same time, the number of model parameters of the neural network model shows an exponential growth trend as the depth of the neural network model continues to increase. For example, the number of parameters has surged from millions a few years ago to hundreds of billions now.

However, the resources of a single computing device are no longer sufficient to operate large-scale neural network models, so the neural network models must be operated in a distributed manner.

### SUMMARY

The present disclosure provides a method for distributed operation based on a neural network model and a related apparatus.

According to one aspect of the present disclosure, provided is a method for distributed operation based on a neural network model, including:
parsing code of the neural network model to construct an operator topology graph corresponding to the neural network model;
generating a distributed operation strategy of the neural network model based on the operator topology graph and a preset resource constraint; and
modifying the code of the neural network model based on the distributed operation strategy to obtain target code; where the target code is used to operate the neural network model based on the distributed operation strategy on a computing device corresponding to the resource constraint.

According to another aspect of the present disclosure, provided is an apparatus for distributed operation based on a neural network model, including:
a parsing module configured to parse code of the neural network model to construct an operator topology graph corresponding to the neural network model;
a determining module configured to generate a distributed operation strategy of the neural network model based on the operator topology graph and a preset resource constraint; and
a modifying module configured to modify the code of the neural network model based on the distributed operation strategy to obtain target code; where the target code is used to operate the neural network model based on the distributed operation strategy on a computing device corresponding to the resource constraint.

According to yet another aspect of the present disclosure, provided is an electronic device, including:
at least one processor; and
a memory connected in communication with the at least one processor;
where the memory stores an instruction executable by the at least one processor, and the instruction, when executed by the at least one processor, enables the at least one processor to execute the method of any embodiment of the present disclosure.

According to yet another aspect of the present disclosure, provided is a non-transitory computer-readable storage medium storing a computer instruction thereon, and the computer instruction is used to cause a computer to execute the method according to any one of the embodiments of the present disclosure.

According to yet another aspect of the present disclosure, provided is a computer program product including a computer program, and the computer program implements the method according to any one of the embodiments of the present disclosure, when executed by a processor.

It should be understood that the content described in this part is not intended to identify critical or essential features of embodiments of the present disclosure, nor is it used to limit the scope of the present disclosure. Other features of the present disclosure will be easily understood through the following description.

### BRIEF DESCRIPTION OF THE DRAWINGS

The accompanying drawings are used to better understand the present solution, and do not constitute a limitation to the present disclosure.

FIG. 1 is a schematic flow chart of a method for distributed operation based on a neural network model according to an embodiment of the present disclosure.

FIG. 2 is a schematic flow chart of constructing an operator topology graph corresponding to the neural network model according to an embodiment of the present disclosure.

FIG. 3 is a schematic diagram of an operator topology graph arranged according to an embodiment of the present disclosure.

FIG. 4 is a schematic diagram of a neural network pattern at last-level granularity according to an embodiment of the present disclosure.

FIG. 5 is a schematic flow chart of generating a distributed operation strategy for the neural network model according to an embodiment of the present disclosure.

FIG. 6 is a schematic flow chart of identifying a neural network pattern at a next higher granularity level according to an embodiment of the present disclosure.

FIG. 7 is a schematic flow chart of updating a matching vector according to an embodiment of the present disclosure.

FIG. 8 is a schematic diagram of a plurality of first candidate patterns according to an embodiment of the present disclosure.

FIG. 9 is a schematic flow chart of obtaining the target code based on the distributed operation strategy according to an embodiment of the present disclosure.

FIG. 10 is a schematic diagram of the overall process of the method for distributed operation based on the neural network model according to an embodiment of the present disclosure.

FIG. 11 is a structural schematic diagram of an apparatus for distributed operation based on a neural network model according to an embodiment of the present disclosure.

FIG. 12 is another structural schematic diagram of an apparatus for distributed operation based on a neural network model according to an embodiment of the present disclosure.

FIG. 13 is a block diagram of an electronic device used to implement the method for distributed operation based on the neural network model according to an embodiment of the present disclosure.

### DETAILED DESCRIPTION

Hereinafter, descriptions to exemplary embodiments of the present disclosure are made with reference to the accompanying drawings, include various details of the embodiments of the present disclosure to facilitate understanding, and should be considered as merely exemplary. Therefore, those having ordinary skill in the art should realize, various changes and modifications may be made to the embodiments described herein, without departing from the scope of the present disclosure. Likewise, for clarity and conciseness, descriptions of well-known functions and structures are omitted in the following descriptions.

In addition, in order to better illustrate the present disclosure, numerous specific details are given in the following specific implementations. Those having ordinary skill in the art should understand that the present disclosure may be performed without certain specific details. In some examples, methods, means, elements and circuits well known to those having ordinary skill in the art are not described in detail, in order to highlight the subject matter of the present disclosure.

The terms “first”, “second” and the like in the present disclosure are used to distinguish the similar objects, but not necessarily to describe a particular order or sequence. In addition, the terms “include” and “have” and any variations thereof are intended to cover a non-exclusive inclusion. For example, a method, system, product or device containing a series of steps or units is not necessarily limited to those steps or units listed clearly, but may include other steps or units that are not listed clearly or that are inherent to the process, method, product or device.

Distribution is a technology that decomposes computing tasks and allocates them to a plurality of computing devices for parallel execution. However, modifying the code of the neural network model to support distribution, add a distributed operation strategy and perform optimization is relatively complex. Professionals are needed to modify the code, and it is difficult for ordinary users to get started and master the modification in a short period of time.

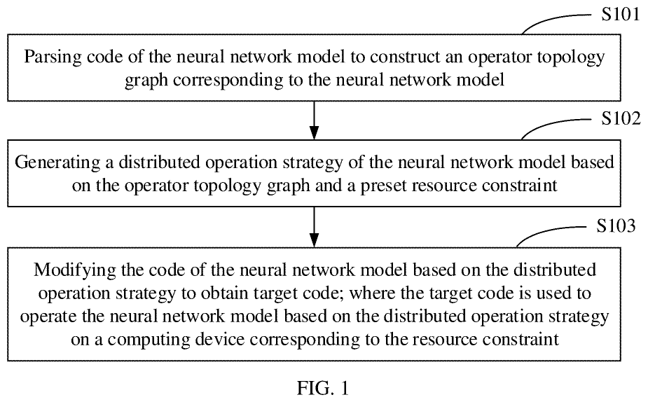

In view of this, an embodiment of the present disclosure provides a method for distributed operation based on a neural network model, as shown in FIG. 1, which is a schematic flow chart of the method, including the following content:

S101: parsing code of the neural network model to construct an operator topology graph corresponding to the neural network model.

Here, the code of the neural network model refers to the code that can run the neural network model to perform a corresponding computing task. The code may be provided by a user. For example, after the user has written the neural network model according to his own requirement, the user may submit the code to execute step S101.

Of course, the distributed operation depends on a computing device, so the user can submit the resource constraint available for running the neural network model. The resource constraint may include the number of computing devices and the situation of available computing units in each computing device. The situation of available computing units may include, for example, the number of available GPU (Graphics Processing Unit) cards, GPU parameters, etc.

Here, some neural network layers are usually used in the code of the neural network model to construct the neural network. The construction of each neural network layer may require at least one operator. Therefore, in order to better determine the distributed operation strategy of the neural network model, the code of the neural network model may be analyzed to thereby construct the operator topology graph corresponding to the neural network model in the embodiment of the present disclosure. The operator topology graph is the structure of the neural network model described by the operator.

S102: generating a distributed operation strategy of the neural network model based on the operator topology graph and a preset resource constraint.

Here, the operator topology graph may globally measure and observe the structure of the neural network model, so as to generate the corresponding distributed operation strategy based on the resource constraint.

S103: modifying the code of the neural network model based on the distributed operation strategy to obtain target code; where the target code is used to operate the neural network model based on the distributed operation strategy on a computing device corresponding to the resource constraint.

Here, the code of the neural network model is modified based on the distributed operation strategy, that is, the code is enabled to carry information about distributed operation, so that the neural network model can be operated in a distributed manner on a plurality of computing devices corresponding to the resource constraint when the target code is run.

In summary, in the embodiment of the present disclosure, the static operator topology graph of the neural network model is firstly constructed based on the code of the neural network model. The operator topology graph can intuitively represent the overall architecture of the neural network model, so as to generate the corresponding distributed operation strategy according to the resource constraint. Then, the code of the neural network model is automatically modified based on the distributed operation strategy to obtain the target code. The entire process can be understood as the conversion from a dynamic graph (i.e., the code of the neural network model) to a static graph (i.e., the operator topology graph). Thus, the distributed operation strategy suitable for the resource constraint can be planned based on the operator topology graph, and finally the dynamic graph is modified to implement distributed operation on the plurality of computing devices. The entire process only requires the user to provide the code of the neural network model and the resource constraint, and the distributed operation strategy can be automatically configured for the user, improving the efficiency of distributed operation of the neural network model and improving the resource utilization of computing devices. In summary, the solution provided by the embodiment of the present disclosure is user-friendly, can adapt to neural network models in any type and with any structure, and supports continuous iterative update of neural network models. Therefore, the dynamic graph is used in the entire process to achieve distributed operation, thus providing the better flexibility, debuggability and maintainability.

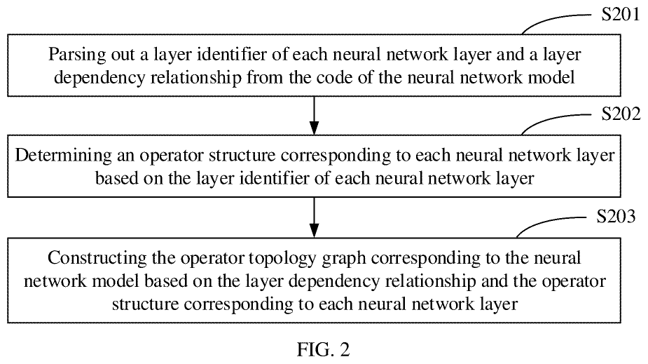

In the embodiment of the present disclosure, the operation mechanism of the neural network model is described with the neural network layer as the minimum granularity in the dynamic graph. However, some neural network layers may include multiple operators. When a specific computing task is executed, the task is executed based on the operators. Therefore, the step of parsing code of the neural network model to construct an operator topology graph corresponding to the neural network model may be implemented as shown in FIG. 2:

S201: parsing out a layer identifier of each neural network layer and a layer dependency relationship from the code of the neural network model.

Here, the layer identifier of the neural network layer is used to uniquely identify the structure of the neural network layer in the code.

S202: determining an operator structure corresponding to each neural network layer based on the layer identifier of each neural network layer.

For example, a convolutional neural network layer may be constructed by multiple operators, such as convolution operation, activation function, batch normalization operator, etc.

Therefore, the corresponding operator can be identified through the layer identifier of the neural network layer, so that the operator with finer granularity than the neural network layer can be used to describe the structure of the neural network model.

S203: constructing the operator topology graph corresponding to the neural network model based on the layer dependency relationship and the operator structure corresponding to each neural network layer.

The operator topology graph is used to describe the dependency relationship among operators. The operator topology graph includes multiple nodes as well as input and output relationships among the multiple nodes, where each node represents an operator.

In the embodiment of the present disclosure, the operators included therein are parsed out layer by layer based on the neural network layers of the neural network model, so that the operator topology graph of the neural network model can be accurately established, thus providing the high-quality data foundation for generating the distributed operation strategy, and improving the efficiency in planning the distributed operation strategy.

In the embodiment of the present disclosure, a neural network pattern at at least one granularity may be pre-established. When multiple granularities are included, neural network patterns from the last-level granularity to the top-level granularity may be included. Here, the neural network pattern at the last-level granularity is relatively small in scale and consists of a small number of operators. From the last-level granularity to the top-level granularity, the complexity of neural network patterns is getting higher and higher. It can be understood that the neural network pattern at the last-level granularity may be used to build the neural network pattern at the top-level granularity. Each neural network pattern at high-level granularity may be built by a neural network pattern at low-level granularity.

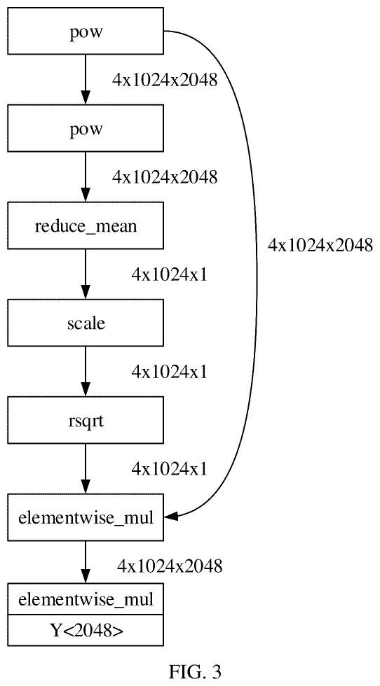

To facilitate understanding of neural network patterns at different granularities, the description will be given below in combination with FIG. 3. For example, FIG. 3 shows an operator topology graph arranged.

Some core operators involved in the neural network patterns in FIG. 3 include: pow (indicating power operation), reduce_mean (indicating addition and averaging operation), scale (indicating multiplication by weight coefficient), rsqrt (indicating square root derivative), and elementwise_mul (indicating element multiplication operation).

The above operators are built according to the topology structure of FIG. 3, which can be called a neural network pattern. The neural network pattern is RMSNorm (Root Mean Square Normalization) pattern.

Similarly, corresponding neural network patterns may be defined based on the mainstream model modules built by multiple operators. For example, neural network patterns with different attention mechanism structures may also be defined based on the attention mechanism, which is not limited in the embodiments of the present disclosure.

Based on FIG. 3, the operator granularity builds a neural network pattern at the last-level granularity, such as the RMSNorm pattern. The neural network pattern at the last-level granularity may build a neural network pattern at a granularity with one level higher than the last-level granularity. For example, the RMSNorm pattern is a component of the transformer, and correspondingly the transformer may be a neural network pattern at a higher granularity.

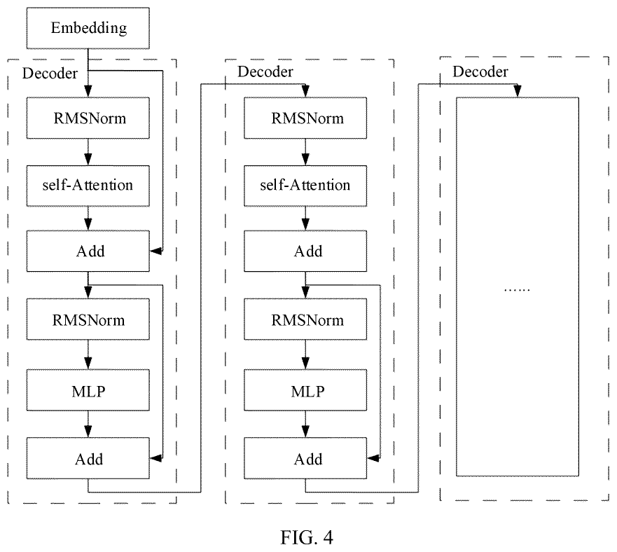

For example, as shown in FIG. 4, each Decoder in FIG. 4 is a neural network pattern at a higher level than the RMSNorm pattern. The neural network patterns at lower-level granularity included in each Decoder pattern include: RMSNorm, self-Attention, Add, RMSNorm, and MLP (Multilayer Perceptron). These neural network patterns at lower-level granularity construct the Decoder pattern at higher-level granularity according to the topology structure of FIG. 4.

In the embodiment of the present disclosure, the neural network pattern at each granularity level may be determined based on known neural network modules so as to be adaptable to most neural network models. These neural network patterns at different granularity levels may be stored in a pattern library for easy use.

Of course, with the update and iteration of the neural network model structure, when a new neural network pattern emerges, the new neural network pattern may be updated into the pattern library.

The pattern library can not only store neural network patterns at different granularity levels, but also correspondingly store the distributed strategies corresponding to the neural network patterns in the pattern library.

As shown in Table 1, sub-strategies used for different neural network patterns under different resource constraints may be constructed. Each sub-strategy represents the distributed operation mode of the neural network model under the corresponding resource constraint. For example, the sub-strategy 1 represents running the neural network pattern 1 based on the data parallel mode in four GPU cards on two computing devices.

TABLE 1

| Identifier of neural network | Resource | Sub-strategy for |
|---|---|---|
| pattern at a granularity level | constraint | distributed operation |
| Neural network pattern 1 | Constraint 1 | Sub-strategy 1 |
| | Constraint 2 | Sub-strategy 2 |
| Neural network pattern 2 | Constraint 1 | Sub-strategy 3 |

Of course, it can be understood that the sub-strategies of different neural network patterns can be updated independently as needed.

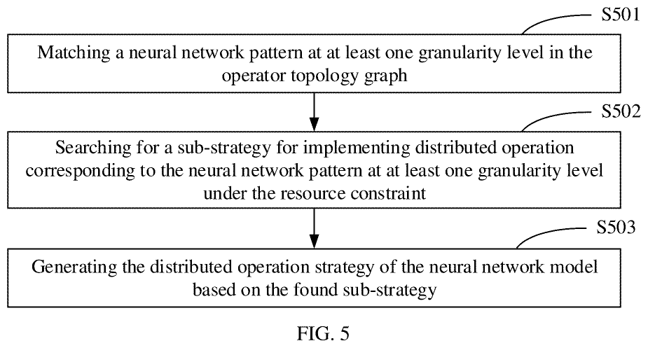

On the basis of constructing the neural network pattern at at least one granularity level and its corresponding sub-strategy, the step of generating a distributed operation strategy of the neural network model based on the operator topology graph and a preset resource constraint in the embodiment of the present disclosure may be implemented as shown in FIG. 5, including the following steps:

S501: matching a neural network pattern at at least one granularity level in the operator topology graph.

Based on the previous description of the neural network patterns, it can be seen that each neural network pattern includes a fixed topology structure. Therefore, neural network patterns at various granularity levels can be matched based on the operator topology graph.

S502: searching for a sub-strategy for implementing distributed operation corresponding to the neural network pattern at at least one granularity level under the resource constraint.

During implementation, in the embodiment of the present disclosure, when there are neural network patterns at multiple granularity levels, the sub-strategies meeting the resource constraint may be searched in order from the top-level granularity to the last-level granularity for a neural network pattern matched at each level of granularity.

For example, the neural network pattern 1 at the top-level granularity includes the neural network pattern 2 and the neural network pattern 3 at the second-top-level granularity. Then it is preferred to search whether the neural network pattern 1 at the top-level granularity is configured with a corresponding sub-strategy under the resource constraint. If no sub-strategy is found, it is possible to further search whether the neural network pattern 2 and the neural network pattern 3 included therein have sub-strategies corresponding to the resource constraint. When the sub-strategies corresponding respectively to the neural network pattern 2 and the neural network pattern 3 are found, these two sub-strategies are jointly constructed as the sub-strategy corresponding to the neural network pattern 1.

If no corresponding sub-strategy is found for the neural network pattern 2 or neural network pattern 3, a corresponding sub-strategy may be searched at the next granularity level, and so on, until a sub-strategy is found or the sub-strategy corresponding to the neural network pattern at the last-level granularity has been searched.

In conclusion, for a neural network pattern matched at any target granularity level, the sub-strategy of the neural network pattern corresponding to the resource constraint is searched. If not found, it is determined whether the next granularity level of the target granularity level contains a sub-pattern contained in the neural network pattern at the target granularity level. In the case of containing a sub-pattern, continue to search for a sub-strategy corresponding to the resource constraint in the sub-pattern. And so on, until the sub-strategy of the neural network pattern at the target granularity level is found or the sub-strategy corresponding to the neural network pattern at the last-level granularity has been searched.

Therefore, this method can preferentially obtain the sub-strategy of the neural network pattern at high-level granularity for distributed operation, improving the efficiency and accuracy in constructing the distributed operation strategy.

In some embodiments, for a neural network pattern matched at any granularity level, the method may also be implemented as follows:

Step A1: for any matched neural network pattern, when no sub-strategy corresponding to the resource constraint is found, constructing a candidate strategy set based on the resource constraint and an operator topology corresponding to the neural network pattern.

For example, the resource constraint input by the user includes 8 cards on a single machine. Then all possible sub-strategies may be generated to obtain a candidate strategy set, including but not limited to:
1) 8 cards are all used for data parallelism;
2) 8 cards are all used for model parallelism;
3) 8 cards are all used for pipeline parallelism;
4) 2 cards are used for data parallelism, and 4 cards are used for model parallelism;
5) 2 cards are used for data parallelism, 2 cards are used for model parallelism, and 2 cards are used for pipeline parallelism.

It should be noted that the above is only used to illustrate the content included in the candidate strategy set and is not used to limit the embodiments of the present disclosure.

Step A2: screening out a sub-strategy corresponding to the neural network pattern from the candidate strategy set with a goal of minimizing a cost function; where the cost function includes at least one of: communication volume, storage volume, or calculation volume.

Here, when the neural network pattern realizes distributed operation, different computing devices or cards may be required to complete, so different computing devices or cards need to communicate with each other to complete the computing tasks. The communication volume is an important factor affecting the task execution efficiency, so the communication volume is taken as an element of the cost function in order to plan a reasonable distributed operation strategy.

When computing tasks are executed, the neural network pattern may generate a large number of intermediate results to be stored, so different distributed strategies have different requirements for the storage volume. Therefore, the storage volume is taken as an element of the cost function in order to plan a reasonable distributed operation strategy.

Different sub-strategies also affect the calculation volume consumed by the neural network pattern, so the calculation volume is taken as an element of the cost function in order to plan a reasonable distributed operation strategy.

In the embodiment of the present disclosure, for each neural network pattern with a known sub-strategy found, the reasonable sub-strategy can be found based on the cost function in combination with the resource constraint, so that the distributed strategy of the entire neural network model can be automatically determined, improving the generation efficiency of the distributed operation strategy.

S503: generating the distributed operation strategy of the neural network model based on the found sub-strategy.

Thus, in the embodiment of the present disclosure, the global structure of the neural network model can be viewed based on the contextual relationship described by the operator topology graph, in order to plan the reasonable sub-strategy and improve the versatility and efficiency in generating the distributed operation strategy.

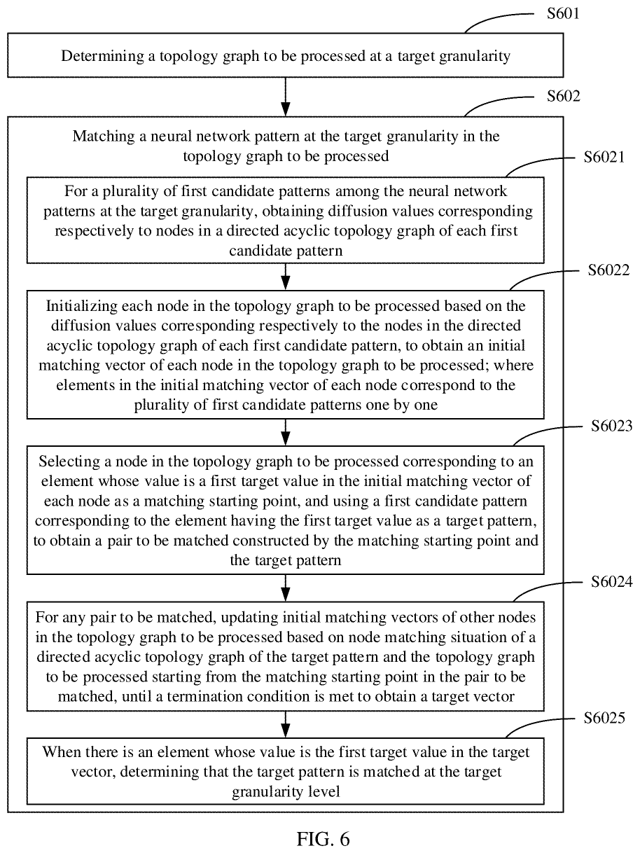

In some embodiments, as described above, the pre-constructed neural network patterns gradually increase from the last-level granularity to the top-level granularity, and correspondingly the step of matching a neural network pattern at at least one granularity level in the operator topology graph may be implemented as shown in FIG. 6:

For the operator topology graph, the following operations are performed in order from the last-level granularity to the top-level granularity until a neural network pattern at the top-level granularity is matched:

S601: determining a topology graph to be processed at a target granularity.

Here, when the target granularity is the last-level granularity, the topology graph to be processed is the operator topology graph; that is, the neural network pattern at the last-level granularity is matched on the operator topology graph.

When the target granularity is other granularity than the last-level granularity, the topology graph to be processed is constructed based on a neural network pattern matched at a previous granularity of the other granularity. That is, after a neural network pattern at any granularity level is matched, the topology graph to be processed is constructed by the topological relationship of the neural network pattern at that granularity level, for identifying a neural network pattern at the next higher granularity level.

Of course, it can be understood that, if an operator does not match a corresponding neural network pattern at the last-level granularity, the operator may be used as the neural network pattern at the last-level granularity. By analogy, for a neural network pattern at the target granularity, if the neural network pattern at the target granularity does not match a corresponding neural network pattern at the next granularity, the neural network pattern at the target granularity may be stored as the neural network pattern at the next granularity.

S602: matching a neural network pattern at the target granularity in the topology graph to be processed.

In the embodiment of the present disclosure, the topology graph is constructed based on neural network patterns at different granularity levels, so that the aggregation of matched neural network patterns can be implemented to thereby identify the neural network patterns at higher granularity levels and accurately understand the structures of the neural network patterns from different granularity levels, so as to ultimately plan a reasonable distributed operation strategy.

In some embodiments, the step of matching a neural network pattern at the target granularity in the topology graph to be processed may be implemented as follows:

Step B1: screening out a node not being a starting point as a matching starting point in the topology graph to be processed.

Here, any neural network pattern has a corresponding topology structure, and the first component executed by the input information thereof is the starting point of the neural network pattern.

Then, any node may become the starting point of one neural network pattern in the topology graph to be processed. In view of this, the matching starting point is preferentially determined in the topology graph to be processed to complete the matching of the neural network pattern at the target granularity in the embodiment of the present disclosure.

Step B2: initializing a matching value of the matching starting point based on starting nodes in respective directed acyclic topology graphs of a plurality of first candidate patterns among the neural network patterns at the target granularity, to obtain an initial matching vector; where there is a correspondence between the plurality of first candidate patterns and elements in the initial matching vector.

The directed acyclic topology graph of the first candidate pattern is established based on the dependency relationship of components contained in the first candidate pattern. For example, the first candidate pattern at the last-level granularity is constructed by the dependency relationship of operators contained, the first candidate pattern at the second-level granularity is constructed by the topological relationship of neural network patterns at the first-level granularity contained, and so on. No detailed description will be given.

Step B3: updating the initial matching vector based on the matching situation of respective directed acyclic topology graphs of the plurality of first candidate patterns and the topology graph to be processed, until a termination condition is met to obtain a target vector.

Here, for any first candidate pattern, the termination condition includes: an element value of the first candidate pattern is a second target value, or the first candidate pattern is matched.

The second target value is used to indicate that there is no topology structure matching the first candidate pattern starting from the matching starting point in the topology graph to be processed.

In the embodiment of the present disclosure, the operation of matching the first candidate pattern can be stopped in time based on the second target value, saving computing resources. By matching the first candidate pattern as the termination condition, the first candidate pattern can be accurately matched. For example, after the first candidate pattern is matched, a topological path matching the first candidate pattern is constructed in the topology graph to be processed based on the matching starting point, and then the topological path is reviewed to see whether it matches the first candidate pattern. If so, it is determined that the termination condition that the first candidate pattern is matched is met.

Step B4: screening out an element whose value is the first target value from the target vector to obtain a target element.

As the name implies, the first target value is used to indicate that the first candidate pattern corresponding to the corresponding element is preliminarily confirmed to have been matched.

The above termination condition aims at a single first candidate pattern or a single element. The embodiment of the present disclosure can simultaneously match the plurality of first candidate patterns by constructing the initial matching vector.

Step B5: determining the first candidate pattern corresponding to the target element as the neural network pattern matched at the target granularity.

The embodiment of the present disclosure can achieve the matching of the neural network pattern starting from any node by screening out the matching starting point, and can achieve simultaneous matching of the plurality of first candidate patterns by constructing the initial matching vector and establishing a correspondence between different first candidate patterns and different elements in the initial matching vector, thereby improving the efficiency in screening out the neural network pattern that can be matched.

In the embodiment of the present disclosure, the neural network pattern with the first target value can be efficiently matched by means of transferring element values. Specifically, step B3 of updating the matching vector based on the matching situation of respective directed acyclic topology graphs of the plurality of first candidate patterns and the topology graph to be processed may be implemented as follows:

Step B31: for any first candidate pattern among the plurality of first candidate patterns, when a value of an element corresponding to the first candidate pattern in the matching vector is not the second target value, determining a current reference node in sequence according to the node dependency relationship in the directed acyclic topology graph of the first candidate pattern.

That is, when the value of the element corresponding to the first candidate pattern is the second target value, the matching of the first candidate pattern is stopped to save computing resources and improve the matching efficiency.

However, when the value of the element corresponding to the first candidate pattern is not the second target value, it is necessary to continue matching the first candidate model.

During specifical matching, the nodes starting from the matching starting point in the topology graph to be processed are compared one by one to see whether they match the corresponding nodes in the first candidate pattern.

Step B32: taking the matching starting point as a reference, and obtaining a node at a path position corresponding to the current reference node in the topology graph to be processed as a node to be compared.

Step B33: when the node to be compared matches the reference node, making the value of the element corresponding to the first candidate pattern inherit the value in the previous round of comparison.

Step B34: when the node to be compared does not match the reference node, making the value of the element corresponding to the first candidate pattern be the second target value.

In the embodiment of the present disclosure, by matching nodes one by one to determine whether to transfer the corresponding element values, the initial matching vector can be quickly updated to improve the matching efficiency.

For example, the structure of the directed acyclic topology graph of the first candidate pattern is: Node A→Node B→Node C.

If the matching starting point matches Node A, the value of the element corresponding to the first candidate pattern in the initial matching vector is the first target value; if not match, the value of the element is updated to the second target value, the matching operation for the first candidate pattern is ended accordingly, and the value of the element is retained as the second target value.

If the matching starting point matches Node A, the value of the element corresponding to the first candidate pattern in the initial matching vector is the first target value; and the next node B continues to be searched as the current reference node according to the node dependency relationship in the directed acyclic topology graph of the first candidate pattern. The downstream node (i.e., D) directly connected to the matching stage is found in the topology graph to be processed as the node to be compared.

If the node to be compared matches the current reference stage, it is determined to inherit the value in the previous round of comparison, that is, the first target value. If not match, the value is updated to the second target value. The subsequent matching process for the first candidate pattern is ended accordingly, and the value corresponding to the element is retained as the second target value.

The aforementioned method requires matching all neural network patterns at the target granularity once for each node in the topology graph to be processed. In order to further improve the matching efficiency, in an embodiment of the present disclosure, as shown in FIG. 6, the step of matching with the neural network patterns at the target granularity in parallel in the topology graph to be processed may be implemented as follows:

S6021: for a plurality of first candidate patterns among the neural network patterns at the target granularity, obtaining diffusion values corresponding respectively to nodes in a directed acyclic topology graph of each first candidate pattern.

For example, in each first candidate pattern, the closer the node is to the starting point node in the directed acyclic topology graph, the higher the diffusion value assigned to the node.

S6022: initializing each node in the topology graph to be processed based on the diffusion values corresponding respectively to the nodes in the directed acyclic topology graph of each first candidate pattern, to obtain an initial matching vector of each node in the topology graph to be processed; where elements in the initial matching vector of each node correspond to the plurality of first candidate patterns one by one.

That is, the value of each node corresponds to the matching situation of each first candidate pattern.

S6023: selecting a node in the topology graph to be processed corresponding to an element whose value is a first target value in the initial matching vector of each node as a matching starting point, and using a first candidate pattern corresponding to the element having the first target value as a target pattern, to obtain a pair to be matched constructed by the matching starting point and the target pattern.

S6024: for any pair to be matched, updating initial matching vectors of other nodes in the topology graph to be processed based on node matching situation of a directed acyclic topology graph of the target pattern and the topology graph to be processed starting from the matching starting point in the pair to be matched, until a termination condition is met to obtain a target vector.

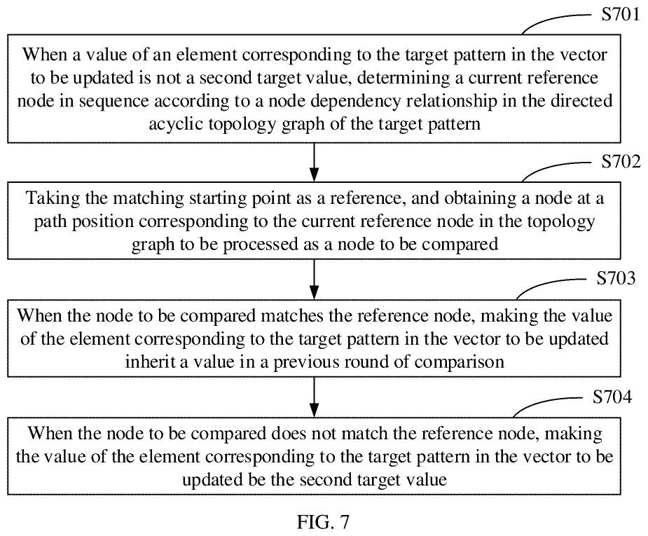

Specifically, as shown in FIG. 7, the following operations may be performed for a vector to be updated starting from the initial matching vector in each round of update:

S701: when a value of an element corresponding to the target pattern in the vector to be updated is not a second target value, determining a current reference node in sequence according to a node dependency relationship in the directed acyclic topology graph of the target pattern.

A702: taking the matching starting point as a reference, and obtaining a node at a path position corresponding to the current reference node in the topology graph to be processed as a node to be compared.

The selection processes of the current reference node and the node to be compared have been described in the above and will not be repeated here.

S703: when the node to be compared matches the reference node, making the value of the element corresponding to the target pattern in the vector to be updated inherit a value in a previous round of comparison.

S704: when the node to be compared does not match the reference node, making the value of the element corresponding to the target pattern in the vector to be updated be the second target value.

Thus, the diffusion values can be passed from the upstream node to the downstream node in sequence according to the matching situation with the target pattern. The updating process can include upstream and downstream matching situation with the target pattern, thus improving the matching accuracy and efficiency.

S6025: when there is an element whose value is the first target value in the target vector, determining that the target pattern is matched at the target granularity level.

Here, S6024 and S6025 are operations performed respectively for each pair to be matched.

In the embodiment of the present disclosure, the starting point of the first candidate pattern that can be matched can be quickly located by initializing the entire topology graph to be processed based on the corresponding diffusion values of the nodes in the first candidate pattern, so that the values of other nodes are updated based on the topology structure to obtain the target vector, and ultimately the matching efficiency can be accelerated.

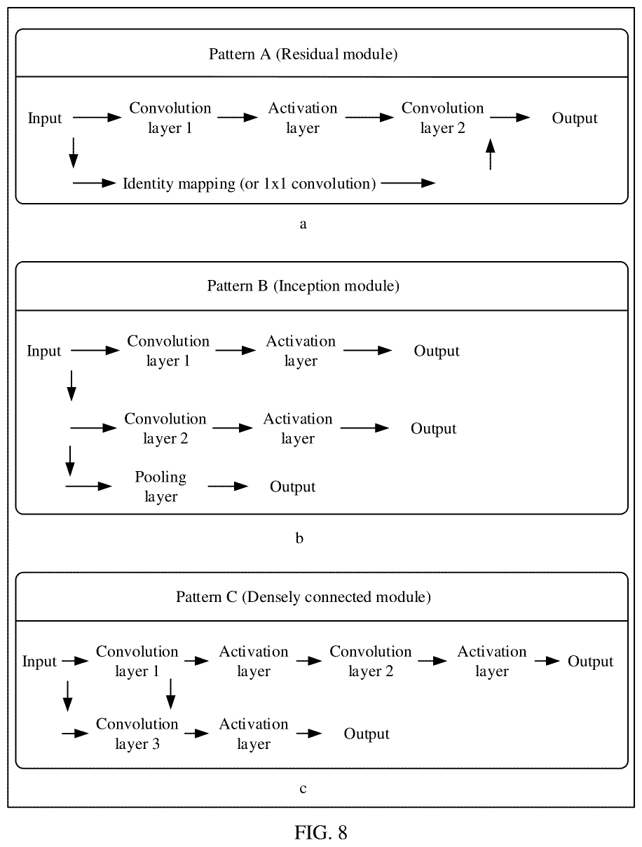

Examples will be given below for further explanation of the operations in FIG. 6 and FIG. 7. For example, a plurality of first candidate patterns may be defined, for example, including: pattern A: a residual module, which has a directed acyclic topology graph as shown in a of FIG. 8; pattern B: an Inception module, which has a directed acyclic topology graph as shown in b of FIG. 8; and pattern C: a densely connected module, which has a directed acyclic topology graph as is shown in c in of FIG. 8. Further, assume that there are the following nodes and dependency relationships in the topology graph to be processed:
1. Node A (convolution layer)→Node B (activation layer)→Node C (convolution layer)→Node D (output)
2. Node A (convolution layer)→Node E (lxi convolution)→Node D (output)
3. Node F (convolution layer)→Node G (activation layer)→Node H (convolution layer)→Node I (activation layer)→Node J (output)
4. Node F (convolution layer)→Node K (convolution layer)→Node L (activation layer)→Node J (output)
5. Node M (convolution layer)→Node N (activation layer)→Node O (pooling layer)→Node P (output)

First, the initial value of each node in the topology graph to be processed is obtained by initialization to obtain the initial matching vector of each node.

When the diffusion values are initialized, one diffusion value needs to be assigned to each target pattern separately and initialized according to the node type or attribute. For example, according to the certain similarity among three first candidate patterns in FIG. 8, the diffusion values of the corresponding nodes matched during initialization of these three patterns are defined as follows:
Convolution layer: initial diffusion value is 1.
Activation layer: initial diffusion value is 0.5.
Pooling layer: initial diffusion value is 0.5.
Other nodes: initial diffusion value is 0.

The initialization results of the initial matching vectors of the nodes are as follows:
1) Convolution layer (such as A, F, M): [1, 1, 1];
2) Activation layer (such as B, G, I, L, N): [0.5, 0.5, 0.5];
3) Pooling layer (such as O): [0, 0.5, 0]; where the matching starting point matches the second node in the first candidate pattern, and the value is 0.5. Here it is stated that only the second node of the second first candidate pattern is matched;
4) Output node (such as D, J, P): [0, 0, 0].

### 1. First Round of Update:

For pattern A:
The diffusion value [1, 0, 0] of node A (related to only the pattern A) is passed to node B and node E:
The diffusion value of node B is updated to [1, 0, 0].
The diffusion value of node E is updated to [1, 0, 0].

For pattern B:
The diffusion value [0, 1, 0] of node F (related to only the pattern B) is passed to node G and node K:
The diffusion value of node G is updated to [0, 0.5, 0].
The diffusion value of node K is updated to [0, 1, 0].

For pattern C:
The diffusion value [0, 0, 1] of node M (related to only the pattern C) is passed to node N:
The diffusion value of node N is updated to [0, 0, 0.5].

### 2. Second Round of Update:

For pattern A:
The diffusion value [1, 0, 0] of node B is passed to node C:
The diffusion value of node C is updated to [1, 0, 0].
The diffusion value [1, 0, 0] of node E is passed to node D:
The diffusion value of node D is updated to [1, 0, 0].

For pattern B:
The diffusion value [0, 0.5, 0] of node G is passed to node H:
The diffusion value of node H is updated to [0, 1, 0].
The diffusion value [0, 1, 0] of node K is passed to node L:
The diffusion value of node L is updated to [0, 1, 0].

For pattern C:
The diffusion value [0, 0, 0.5] of node N is passed to node O:
The diffusion value of node O is updated to [0, 0.5, 1].

### 3. The Third Round of Update:

For pattern A:
The diffusion value [1, 0, 0] of node C is passed to node D:
The diffusion value of node D is further accumulated as [1, 0, 0].

For pattern B:
The diffusion value [0, 1, 0] of node H and node L is passed to node J:
The diffusion value of node J is updated to [0, 1, 0].

For pattern C:
The diffusion value [0, 0.5, 1] of node O is passed to node P:
The diffusion value of node P is updated to [0, 0.5, 1].

After the updates are finished, which nodes have the highest diffusion values are checked:
1) The diffusion value of node D is [1, 0, 0], indicating that node D matches pattern A (residual module).
2) The diffusion value of node J is [0, 1, 0], indicating that node J matches pattern B (Inception module).
3) The diffusion value of node P is [0, 0.5, 1], indicating that node P matches pattern C (densely connected module).

By path backtracking, it can be verified whether these nodes indeed form any one of the first candidate patterns described above.

In some other embodiments, in addition to the above-mentioned matching method, the neural network model may also be matched in the following manner, including:
Step C1: screening out a node not being a starting point as a matching starting point according to a topology structure of the topology graph to be processed in the topology graph to be processed;
Step C2: screening out a neural network pattern with a starting point being the matching starting point from neural network patterns at the target granularity, to obtain at least one second candidate pattern;
Step C3: obtaining a next point to be matched in the topology graph to be processed starting from the matching starting point; and
Step C4: screening out a new second candidate pattern from the at least one second candidate pattern based on the next point to be matched, and returning the step of obtaining a next point to be matched in the topology graph to be processed until an end condition is met; where the end condition includes: a neural network pattern is matched among the neural network patterns at the target granularity, or there is no matching neural network pattern at the target granularity starting from the matching starting point.

For example, assuming that the topology graph to be processed is as shown in FIG. 3, and assuming that the POW operator is used as the matching starting point, the neural network pattern starting with the POW operator may be screened out from the neural network patterns at the last-level granularity as the second candidate pattern. Then, relying on the topology structure of FIG. 2, the next point to be matched is selected as reduce_mean, and the second candidate pattern whose first node is reduce_mean is selected from the above-mentioned second candidate patterns to construct a new second candidate pattern, and so on, until the neural network pattern at the target granularity is matched or the matching fails. If the matching fails, it means that the selected matching starting point is not the starting point of any neural network pattern at the target granularity. The matching starting point may be re-selected and the above operations may be repeated.

In the embodiment of the present disclosure, the matching range of the neural network pattern can be reduced layer by layer depending on the topological relationship of the topology graph to be processed, and ultimately the desired neural network pattern can be accurately matched.

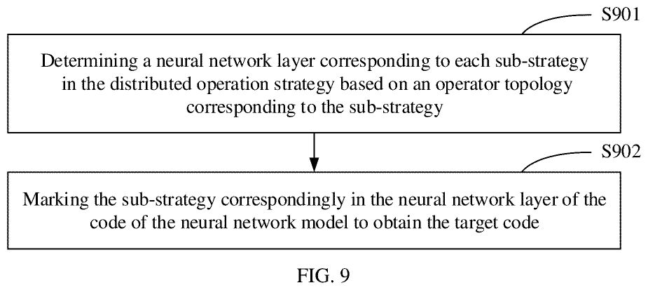

In some embodiments, after the distributed parallel strategy of the neural network model is generated, the step of modifying the code of the neural network model based on the distributed operation strategy to obtain the target code may be implemented as shown in FIG. 9:

S901: determining a neural network layer corresponding to each sub-strategy in the distributed operation strategy based on an operator topology corresponding to the sub-strategy.

That is, when the operator topology graph is established described above, a correspondence between neural network layers and local operator topologies is simultaneously recorded. Therefore, the corresponding neural network layer can be accurately extracted after the sub-strategy is determined.

S902: marking the sub-strategy correspondingly in the neural network layer of the code of the neural network model to obtain the target code.

During implementation, a correspondence between markers of distributed strategies and executable codes may be established, so that the corresponding implementable code can be found based on the marker when the target code is executed to the marker, to achieve distributed operation. In this way, the distributed operation codes of different sub-strategies can be maintained separately, thereby improving the maintainability of the distributed operation codes.

In the embodiment of the present disclosure, the distributed strategy planned from the static graph can be accurately marked back into the neural network of the dynamic graph by marking the granularity of the corresponding neural network layer, thereby realizing the conversion from the static graph to the dynamic graph, facilitating the distributed operation of the neural network model based on the dynamic graph, and improving the flexibility, maintainability and debuggability of the neural network model.

In an embodiment of the present disclosure, in order to improve the efficiency of distributed operation and improve the resource utilization of computing devices, the distributed operation strategy includes at least one of the following distributed operation modes:
1) Data parallel mode: data parallelism means dividing the training data into multiple mini-batches and distributing these mini-batches to multiple devices (such as GPUs or TPUs) for independent calculation. The devices run the same model copy but process different data subsets.
2) Model parallel mode: model parallelism means splitting a very large model into multiple parts and distributing these parts to different computing devices. Each device is responsible for computing only a part of the model instead of the entire model.
3) Pipeline parallel mode: pipeline parallelism is a strategy combining data parallelism and model parallelism. The model is split into multiple stages and the stages are distributed to different devices. At the same time, the stages process different data batches to form pipeline parallel calculation.

The embodiment of the present disclosure can improve the flexibility in planning the distributed parallel strategy and the efficiency of distributed parallel processing by supporting different parallel modes, thereby improving the resource utilization of computing devices.

In some embodiments, the neural network model in the embodiments of the present disclosure may support different tasks for processing at least one of: audio, text, video, or picture.

Therefore, by supporting the processing of data in different modalities, corresponding neural network models can be designed according to actual service requirements to meet different service requirements of users.

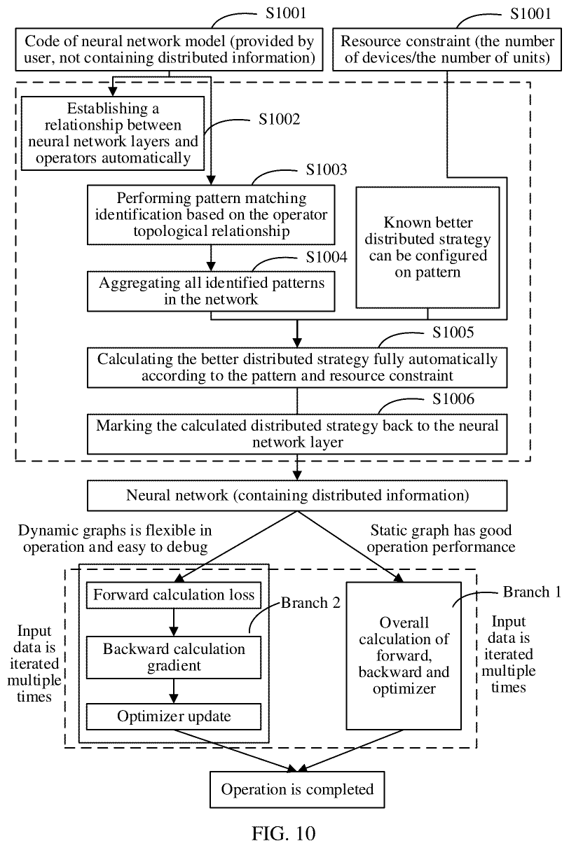

For ease of understanding, assume that two granularity levels are retained: the neural network pattern at the last-level granularity and the neural network pattern at the top-level granularity. The overall processing flow of the embodiment of the present disclosure is shown in FIG. 10, including:

S1001: obtaining the code of a neural network model and a resource constraint provided by a user.

Here, the resource constraint includes the number of available computing devices and the number of available computing units (such as GPU cards and/or TPU cards) per device.

S1002: establishing a relationship between neural network layers and operators automatically according to the code of the neural network.

S1003: constructing an operator topology graph based on a relationship among operators, and performing pattern identification based on the operator topology graph to identify neural network patterns at the last-level granularity.

S1004: constructing a new topology graph based on the neural network patterns at the last-level granularity to aggregate the neural network patterns at the last-level granularity and obtain a matching neural network pattern at the top-level granularity.

S1005: searching for a sub-strategy with better technology for distributed operation automatically according to the identified neural network pattern at each level of granularity and the resource constraint, to thereby obtain a distributed operation strategy for the entire neural network model.

For example, the better sub-strategy applicable to the identified neural network pattern is automatically determined according to the neural network pattern, the known better distributed strategy configured for the neural network pattern and the resource constraint. If the known better distributed strategy has been configured for the neural network pattern, the strategy can be used to narrow the selection range of distributed strategy and speed up the calculation. For example, in an operator topology of the MLP pattern, this pattern may be configured according to the optimal distributed strategy known from practical experience as follows: the weights of the first two matmul operators may be split by columns, and the weight of the last matmul operator may be split by rows. This strategy can maximize the parallel calculation and minimize the communication volume, and then determine how many parts to split by columns and rows based on resource constraints. For example, if there are 4 computing devices, the best strategy may be cutting them into 4 parts; if there are 8 computing devices, the best strategy may be cutting them into 4 or 8 parts. If no corresponding optimal splitting method is found, the cost function may be calculated relatively for the two splitting methods to thereby screen out a better sub-strategy for distributed operation.

S1006: marking the neural network layer of the neural network model based on the distributed operation strategy.

Here, the neural network can be run by means of the dynamic graph or static graph by marking back the neural network layer. The former has flexibility and debuggability, and the latter has high performance. As can be seen from the above steps, the pattern identification and aggregation have no restriction on the type and structure of the neural network and no restriction on the distributed parallel strategy that can be used, and have universality. Moreover, the marking of the distributed strategy is completely automatically calculated and implemented by the system, and the user does not need to understand the distributed concept or modify and add the distributed code, so the distributed strategy is easy to use and maintain.

As shown in Branch 1 on the right side of FIG. 10, when running according to the static graph, the neural network model is run according to the entire fixed operator topology structure in the static graph. If the neural network model is modified, the distributed operation strategy corresponding to the operator topology graph will become invalid. Moreover, during the overall operation, it is impossible to locate which module or link has a problem, and it is not easy to locate and debug when a problem occurs.

As shown in Branch 2 on the left side of FIG. 10, the static graph is used to plan the distributed operation strategy, and then the neural network layer is marked back. Each module may be debugged separately, such as forward calculation loss, backward calculation gradient and optimizer risk. Thus, it is easy to locate and debug when a problem occurs. Moreover, when the code of the neural network model is updated, the solution of the present disclosure can still be used to automatically plan the distributed operation strategy. The user only needs to provide the code and resource constraints.

In summary, the method provided in the embodiments of the present disclosure enables the ordinary user to use the distributed technology in the deep neural network with one click, satisfying:
Usability requirement: user-friendly, the user is not required to understand the concept of distribution before use;
Maintainability requirement: when using any distributed strategy, there is no need to make distributed modification to the original neural network code, and there is no subsequent maintenance cost;
Universality requirement: there is no restriction on the type and structure of the neural network and no restriction on the distributed parallel strategy that can be used;
Flexibility requirement: there is an ability to run by means of dynamic graph, that is, support the use of different deep neural networks or different branches in different iterations; and
Debuggability requirement: when a problem occurs, there is no need to add additional operators, and the input and output of each operator in the deep neural network can be debugged to quickly locate the problem.

The method provided in the embodiments of the present disclosure can be applied to the code of the deep neural network model. The solution provided in the embodiments of the present disclosure can realize distributed operation without the need for the user to modify the code, thereby solving the problem that the increase in the number of parameters causes no space inside the device or slow calculation.

If the distributed parallel strategy suitable for the model network is unknown and the system is expected to provide a better distributed operation scheme, the solution provided in the embodiments of the present disclosure may also be selected.

Moreover, for the exploration of cutting-edge algorithms, the solution provided in the embodiments of the present disclosure is also applicable when distributed operation is required and the algorithm will be flexibly modified and debugged during the exploration process.

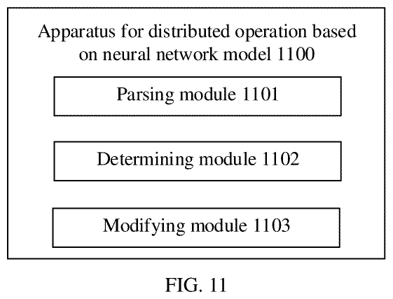

Based on the same technical concept, an embodiment of the present disclosure further proposes an apparatus 1100 for distributed operation based on a neural network model, as shown in FIG. 11, including:
a parsing module 1101 configured to parse code of the neural network model to construct an operator topology graph corresponding to the neural network model;
a determining module 1102 configured to generate a distributed operation strategy of the neural network model based on the operator topology graph and a preset resource constraint; and
a modifying module 1103 configured to modify the code of the neural network model based on the distributed operation strategy to obtain target code; where the target code is used to operate the neural network model based on the distributed operation strategy on a computing device corresponding to the resource constraint.

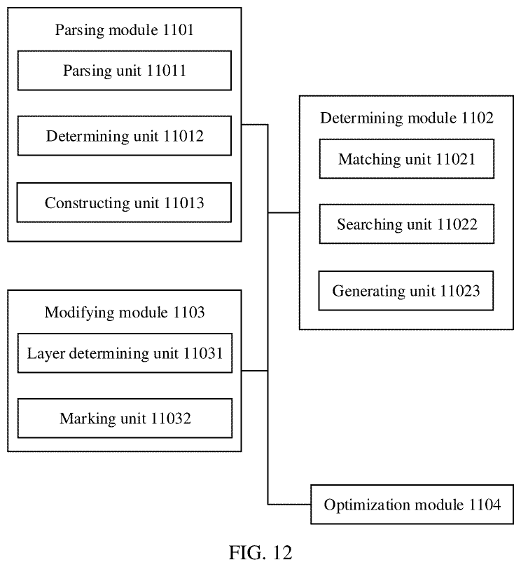

In some embodiments, as shown in FIG. 12, the parsing module 1101 includes:
a parsing unit 11011 configured to parse out a layer identifier of each neural network layer and a layer dependency relationship from the code of the neural network model;
a determining unit 11012 configured to determine an operator structure corresponding to each neural network layer based on the layer identifier of each neural network layer; and
a constructing unit 11013 configured to construct the operator topology graph corresponding to the neural network model based on the layer dependency relationship and the operator structure corresponding to each neural network layer.

In some embodiments, as shown in FIG. 12, the determining module 1102 includes:
a matching unit 11021 configured to match a neural network pattern at at least one granularity level in the operator topology graph;
a searching unit 11022 configured to search for a sub-strategy for implementing distributed operation corresponding to the neural network pattern at at least one granularity level under the resource constraint; and
a generating unit 11023 configured to generate the distributed operation strategy of the neural network model based on the found sub-strategy.

In some embodiments, pre-constructed neural network patterns gradually increase from a last-level granularity to a top-level granularity, and the matching unit 11021 is specifically configured to:
for the operator topology graph, perform following operations in order from the last-level granularity to the top-level granularity until a neural network pattern at the top-level granularity is matched:
determining a topology graph to be processed at a target granularity; and
matching a neural network pattern at the target granularity in the topology graph to be processed;
where, when the target granularity is the last-level granularity, the topology graph to be processed is the operator topology graph; and
when the target granularity is other granularity than the last-level granularity, the topology graph to be processed is constructed based on a neural network pattern matched at a previous granularity of the other granularity.

In some embodiments, the matching unit 11021 is specifically configured to:
for a plurality of first candidate patterns among neural network patterns at the target granularity, obtain diffusion values corresponding respectively to nodes in a directed acyclic topology graph of each first candidate pattern;
initialize each node in the topology graph to be processed based on the diffusion values corresponding respectively to the nodes in the directed acyclic topology graph of each first candidate pattern, to obtain an initial matching vector of each node in the topology graph to be processed; where elements in the initial matching vector of each node correspond to the plurality of first candidate patterns one by one;
select a node in the topology graph to be processed corresponding to an element whose value is a first target value in the initial matching vector of each node as a matching starting point, and use a first candidate pattern corresponding to the element having the first target value as a target pattern, to obtain a pair to be matched constructed by the matching starting point and the target pattern;
for any pair to be matched, update initial matching vectors of other nodes in the topology graph to be processed based on node matching situation of a directed acyclic topology graph of the target pattern and the topology graph to be processed starting from the matching starting point in the pair to be matched, until a termination condition is met to obtain a target vector; and
when there is an element whose value is the first target value in the target vector, determine that the target pattern is matched at the target granularity level.

In some embodiments, for any first candidate pattern, the termination condition includes: an element value of the first candidate pattern is a second target value, or the first candidate pattern is matched.

In some embodiments, the matching unit 11021 is specifically configured to:
perform following operations for a vector to be updated starting from the initial matching vector in each round of update:
when a value of an element corresponding to the target pattern in the vector to be updated is not a second target value, determining a current reference node in sequence according to a node dependency relationship in the directed acyclic topology graph of the target pattern;
taking the matching starting point as a reference, and obtaining a node at a path position corresponding to the current reference node in the topology graph to be processed as a node to be compared;
when the node to be compared matches the reference node, making the value of the element corresponding to the target pattern in the vector to be updated inherit a value in a previous round of comparison; and
when the node to be compared does not match the reference node, making the value of the element corresponding to the target pattern in the vector to be updated be the second target value.

In some embodiments, the matching unit 11021 is specifically configured to:
screen out a node not being a starting point as a matching starting point according to a topology structure of the topology graph to be processed in the topology graph to be processed;
screen out a neural network pattern with a starting point being the matching starting point from neural network patterns at the target granularity, to obtain at least one second candidate pattern;
obtain a next point to be matched in the topology graph to be processed starting from the matching starting point; and
screen out a new second candidate pattern from the at least one second candidate pattern based on the next point to be matched, and return the step of obtaining a next point to be matched in the topology graph to be processed until an end condition is met;
where the end condition includes: a neural network pattern is matched among the neural network patterns at the target granularity, or there is no matching neural network pattern at the target granularity starting from the matching starting point.

In some embodiments, the searching unit 11022 is specifically configured to:
for a neural network pattern matched at each level of granularity, search for a sub-strategy meeting the resource constraint in order from a top-level granularity to a last-level granularity.

In some embodiments, as shown in FIG. 12, the modifying module 1103 includes:
a layer determining unit 11031 configured to determine a neural network layer corresponding to each sub-strategy in the distributed operation strategy based on an operator topology corresponding to the sub-strategy; and
a marking unit 11032 configured to mark the sub-strategy correspondingly in the neural network layer of the code of the neural network model to obtain the target code.

In some embodiments, as shown in FIG. 12, the apparatus further includes an optimization module 1104 configured to:
for any matched neural network pattern, when no sub-strategy corresponding to the resource constraint is found, construct a candidate strategy set based on the resource constraint and an operator topology corresponding to the neural network pattern; and
screen out a sub-strategy corresponding to the neural network pattern from the candidate strategy set with a goal of minimizing a cost function;
where the cost function includes at least one of: communication volume, storage volume, or calculation volume.

In some embodiments, the distributed operation strategy includes at least one of: data parallel mode, model parallel mode, or pipeline parallel mode.

In some embodiments, the neural network model is used to process at least one of: audio, text, video, or picture.

For the description of specific functions and examples of the modules and sub-modules of the apparatus of the embodiment of the present disclosure, reference may be made to the relevant description of the corresponding steps in the above-mentioned method embodiments, and details are not repeated here.

In the technical solution of the present disclosure, the acquisition, storage and application of the user's personal information involved are in compliance with relevant laws and regulations, and do not violate public order and good customs.

According to the embodiments of the present disclosure, the present disclosure also provides an electronic device, a readable storage medium and a computer program product.

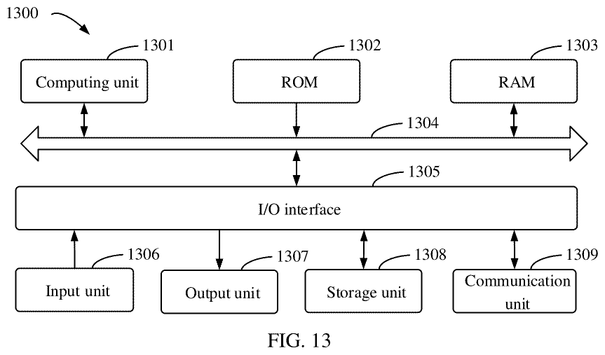

FIG. 13 shows a schematic block diagram of an exemplary electronic device 1300 that may be used to implement the embodiments of the present disclosure. The electronic device is intended to represent various forms of digital computers, such as a laptop, a desktop, a workstation, a personal digital assistant, a server, a blade server, a mainframe computer, and other suitable computers. The electronic device may also represent various forms of mobile devices, such as a personal digital assistant, a cellular phone, a smart phone, a wearable device and other similar computing devices. The components shown herein, their connections and relationships, and their functions are merely examples, and are not intended to limit the implementation of the present disclosure described and/or required herein.

As shown in FIG. 13, the device 1300 includes a computing unit 1301 that may perform various appropriate actions and processes according to a computer program stored in a Read-Only Memory (ROM) 1302 or a computer program loaded from a storage unit 1308 into a Random Access Memory (RAM) 1303. Various programs and data required for an operation of device 1300 may also be stored in the RAM 1303. The computing unit 1301, the ROM 1302 and the RAM 1303 are connected to each other through a bus 1304. The input/output (I/O) interface 1305 is also connected to the bus 1304.

A plurality of components in the device 1300 are connected to the I/O interface 1305, and include an input unit 1306 such as a keyboard, a mouse, or the like; an output unit 1307 such as various types of displays, speakers, or the like; the storage unit 1308 such as a magnetic disk, an optical disk, or the like; and a communication unit 1309 such as a network card, a modem, a wireless communication transceiver, or the like. The communication unit 1309 allows the device 1300 to exchange information/data with other devices through a computer network such as the Internet and/or various telecommunication networks.

The computing unit 1301 may be various general-purpose and/or special-purpose processing components with processing and computing capabilities. Some examples of the computing unit 1301 include, but are not limited to, a Central Processing Unit (CPU), a Graphics Processing Unit (GPU), various dedicated Artificial Intelligence (AI) computing chips, various computing units that run machine learning model algorithms, a Digital Signal Processor (DSP), and any appropriate processors, controllers, microcontrollers, or the like. The computing unit 1301 performs various methods and processes described above, such as the method for distributed operation based on the neural network model. For example, in some implementations, the method for distributed operation based on the neural network model may be implemented as a computer software program tangibly contained in a computer-readable medium, such as the storage unit 1308. In some implementations, a part or all of the computer program may be loaded and/or installed on the device 1300 via the ROM 1302 and/or the communication unit 1309. When the computer program is loaded into the RAM 1303 and executed by the computing unit 1301, one or more steps of the method for distributed operation based on the neural network model described above may be performed. Alternatively, in other implementations, the computing unit 1301 may be configured to perform the method for distributed operation based on the neural network model by any other suitable means (e.g., by means of firmware).

Various implementations of the system and technologies described above herein may be implemented in a digital electronic circuit system, an integrated circuit system, a Field Programmable Gate Array (FPGA), an Application Specific Integrated Circuit (ASIC), an Application Specific Standard Product (ASSP), a System on Chip (SOC), a Complex Programmable Logic Device (CPLD), a computer hardware, firmware, software, and/or a combination thereof. These various implementations may be implemented in one or more computer programs, and the one or more computer programs may be executed and/or interpreted on a programmable system including at least one programmable processor. The programmable processor may be a special-purpose or general-purpose programmable processor, may receive data and instructions from a storage system, at least one input device, and at least one output device, and transmit the data and the instructions to the storage system, the at least one input device, and the at least one output device.

The program code for implementing the method of the present disclosure may be written in any combination of one or more programming languages. The program code may be provided to a processor or controller of a general-purpose computer, a special-purpose computer or other programmable data processing devices, which enables the program code, when executed by the processor or controller, to cause the function/operation specified in the flowchart and/or block diagram to be implemented. The program code may be completely executed on a machine, partially executed on the machine, partially executed on the machine as a separate software package and partially executed on a remote machine, or completely executed on the remote machine or a server.

In the context of the present disclosure, a machine-readable medium may be a tangible medium, which may contain or store a procedure for use by or in connection with an instruction execution system, device or apparatus. The machine-readable medium may be a machine-readable signal medium or a machine-readable storage medium. The machine-readable medium may include, but is not limited to, an electronic, magnetic, optical, electromagnetic, infrared or semiconductor system, device or apparatus, or any suitable combination thereof. More specific examples of the machine-readable storage medium may include electrical connections based on one or more lines, a portable computer disk, a hard disk, a Random Access Memory (RAM), a Read-Only Memory (ROM), an Erasable Programmable Read-Only Memory (EPROM or a flash memory), an optical fiber, a portable Compact Disc Read-Only Memory (CD-ROM), an optical storage device, a magnetic storage device, or any suitable combination thereof.

In order to provide interaction with a user, the system and technologies described herein may be implemented on a computer that has: a display apparatus (e.g., a cathode ray tube (CRT) or a Liquid Crystal Display (LCD) monitor) for displaying information to the user; and a keyboard and a pointing device (e.g., a mouse or a trackball) through which the user may provide input to the computer. Other types of devices may also be used to provide interaction with the user. For example, feedback provided to the user may be any form of sensory feedback (e.g., visual feedback, auditory feedback, or tactile feedback), and the input from the user may be received in any form (including an acoustic input, a voice input, or a tactile input).

The system and technologies described herein may be implemented in a computing system (which serves as, for example, a data server) including a back-end component, or in a computing system (which serves as, for example, an application server) including a middleware, or in a computing system including a front-end component (e.g., a user computer with a graphical user interface or web browser through which the user may interact with the implementation of the system and technologies described herein), or in a computing system including any combination of the back-end component, the middleware component, or the front-end component. The components of the system may be connected to each other through any form or kind of digital data communication (e.g., a communication network). Examples of the communication network include a Local Area Network (LAN), a Wide Area Network (WAN), and the Internet.

A computer system may include a client and a server. The client and server are generally far away from each other and usually interact with each other through a communication network. A relationship between the client and the server is generated by computer programs running on corresponding computers and having a client-server relationship with each other. The server may be a cloud server, a distributed system server, or a blockchain server.

It should be understood that, the steps may be reordered, added or removed by using the various forms of the flows described above. For example, the steps recorded in the present disclosure can be performed in parallel, in sequence, or in different orders, as long as a desired result of the technical scheme disclosed in the present disclosure can be realized, which is not limited herein.

The foregoing specific implementations do not constitute a limitation on the protection scope of the present disclosure. Those having ordinary skill in the art should understand that, various modifications, combinations, sub-combinations and substitutions may be made according to a design requirement and other factors. Any modification, equivalent replacement, improvement or the like made within the principle of the present disclosure shall be included in the protection scope of the present disclosure.

1. A method for distributed operation based on a neural network model, comprising:
parsing code of the neural network model to construct an operator topology graph corresponding to the neural network model;
generating a distributed operation strategy of the neural network model based on the operator topology graph and a preset resource constraint; and
modifying the code of the neural network model based on the distributed operation strategy to obtain target code; wherein the target code is used to operate the neural network model based on the distributed operation strategy on a computing device corresponding to the resource constraint.

2. The method of claim 1, wherein the parsing code of the neural network model to construct the operator topology graph corresponding to the neural network model, comprises:
parsing out a layer identifier of each neural network layer and a layer dependency relationship from the code of the neural network model;
determining an operator structure corresponding to each neural network layer based on the layer identifier of each neural network layer; and
constructing the operator topology graph corresponding to the neural network model based on the layer dependency relationship and the operator structure corresponding to each neural network layer.

3. The method of claim 1, wherein generating the distributed operation strategy of the neural network model based on the operator topology graph and the preset resource constraint, comprises:
matching a neural network pattern at at least one granularity level in the operator topology graph;
searching for a sub-strategy for implementing distributed operation corresponding to the neural network pattern at at least one granularity level under the resource constraint; and
generating the distributed operation strategy of the neural network model based on the found sub-strategy.

4. The method of claim 3, wherein pre-constructed neural network patterns gradually increase from a last-level granularity to a top-level granularity, and matching the neural network pattern at the at least one granularity level in the operator topology graph, comprises:
for the operator topology graph, performing following operations in order from the last-level granularity to the top-level granularity until a neural network pattern at the top-level granularity is matched:
determining a topology graph to be processed at a target granularity; and
matching a neural network pattern at the target granularity in the topology graph to be processed;
wherein, in a case of the target granularity is the last-level granularity, the topology graph to be processed is the operator topology graph; and
in a case of the target granularity is other granularity than the last-level granularity, the topology graph to be processed is constructed based on a neural network pattern matched at a previous granularity of the other granularity.

5. The method of claim 4, wherein matching the neural network pattern at the target granularity in the topology graph to be processed, comprises:
for a plurality of first candidate patterns among neural network patterns at the target granularity, obtaining diffusion values corresponding respectively to nodes in a directed acyclic topology graph of each first candidate pattern;
initializing each node in the topology graph to be processed based on the diffusion values corresponding respectively to the nodes in the directed acyclic topology graph of each first candidate pattern, to obtain an initial matching vector of each node in the topology graph to be processed; wherein elements in the initial matching vector of each node correspond to the plurality of first candidate patterns one by one;
selecting a node in the topology graph to be processed corresponding to an element whose value is a first target value in the initial matching vector of each node as a matching starting point, and using a first candidate pattern corresponding to the element having the first target value as a target pattern, to obtain a pair to be matched constructed by the matching starting point and the target pattern;
for any pair to be matched, updating initial matching vectors of other nodes in the topology graph to be processed based on node matching situation of a directed acyclic topology graph of the target pattern and the topology graph to be processed starting from the matching starting point in the pair to be matched, until a termination condition is met to obtain a target vector; and
in a case of there is an element whose value is the first target value in the target vector, determining that the target pattern is matched at the target granularity.

6. The method of claim 5, wherein, for any first candidate pattern, the termination condition comprises: an element value of the first candidate pattern is a second target value, or the first candidate pattern is matched.

7. The method of claim 5, wherein updating the initial matching vectors of the other nodes in the topology graph to be processed based on the node matching situation of the directed acyclic topology graph of the target pattern and the topology graph to be processed, comprises:
performing following operations for a vector to be updated starting from the initial matching vector in each round of update:
in a case of a value of an element corresponding to the target pattern in the vector to be updated is not a second target value, determining a current reference node in sequence according to a node dependency relationship in the directed acyclic topology graph of the target pattern;
taking the matching starting point as a reference, and obtaining a node at a path position corresponding to the current reference node in the topology graph to be processed as a node to be compared;
in a case of the node to be compared matches the reference node, making the value of the element corresponding to the target pattern in the vector to be updated inherit a value in a previous round of comparison; and
in a case of the node to be compared does not match the reference node, making the value of the element corresponding to the target pattern in the vector to be updated be the second target value.

8. The method of claim 4, wherein matching the neural network pattern at the target granularity in the topology graph to be processed, comprises:
screening out a node not being a starting point as a matching starting point according to a topology structure of the topology graph to be processed in the topology graph to be processed;
screening out a neural network pattern with a starting point being the matching starting point from neural network patterns at the target granularity, to obtain at least one second candidate pattern;
obtaining a next point to be matched in the topology graph to be processed starting from the matching starting point; and
screening out a new second candidate pattern from the at least one second candidate pattern based on the next point to be matched, and returning the step of obtaining a next point to be matched in the topology graph to be processed until an end condition is met;
wherein the end condition comprises: a neural network pattern is matched among the neural network patterns at the target granularity, or there is no matching neural network pattern at the target granularity starting from the matching starting point.

9. The method of claim 3, wherein searching for the sub-strategy for implementing distributed operation corresponding to the neural network pattern at at least one granularity level under the resource constraint, comprises:
for a neural network pattern matched at each level of granularity, searching for a sub-strategy meeting the resource constraint in order from a top-level granularity to a last-level granularity.

10. The method of claim 1, wherein modifying the code of the neural network model based on the distributed operation strategy to obtain the target code, comprises:
determining a neural network layer corresponding to each sub-strategy in the distributed operation strategy based on an operator topology corresponding to the sub-strategy; and
marking the sub-strategy correspondingly in the neural network layer of the code of the neural network model to obtain the target code.

11. The method of claim 3, further comprising:
for any matched neural network pattern, in a case of no sub-strategy corresponding to the resource constraint is found, constructing a candidate strategy set based on the resource constraint and an operator topology corresponding to the neural network pattern; and
screening out a sub-strategy corresponding to the neural network pattern from the candidate strategy set with a goal of minimizing a cost function;
wherein the cost function comprises at least one of: communication volume, storage volume, or calculation volume.

12. The method of claim 1, wherein the distributed operation strategy comprises at least one of:
data parallel mode, model parallel mode, or pipeline parallel mode.

13. The method of claim 1, wherein the neural network model is used to process at least one of:
audio, text, video, or picture.

14. An electronic device, comprising:
at least one processor; and
a memory connected in communication with the at least one processor;
wherein the memory stores an instruction executable by the at least one processor, and the instruction, when executed by the at least one processor, enables the at least one processor to execute:
parsing code of a neural network model to construct an operator topology graph corresponding to the neural network model;
generating a distributed operation strategy of the neural network model based on the operator topology graph and a preset resource constraint; and
modifying the code of the neural network model based on the distributed operation strategy to obtain target code; wherein the target code is used to operate the neural network model based on the distributed operation strategy on a computing device corresponding to the resource constraint.

15. The electronic device of claim 14, wherein the instruction, when executed by the at least one processor, enables the at least one processor to execute the parsing code of the neural network model to construct the operator topology graph corresponding to the neural network model, by:
parsing out a layer identifier of each neural network layer and a layer dependency relationship from the code of the neural network model;
determining an operator structure corresponding to each neural network layer based on the layer identifier of each neural network layer; and
constructing the operator topology graph corresponding to the neural network model based on the layer dependency relationship and the operator structure corresponding to each neural network layer.

16. The electronic device of claim 14, wherein the instruction, when executed by the at least one processor, enables the at least one processor to execute generating the distributed operation strategy of the neural network model based on the operator topology graph and the preset resource constraint, by:
matching a neural network pattern at at least one granularity level in the operator topology graph;
searching for a sub-strategy for implementing distributed operation corresponding to the neural network pattern at at least one granularity level under the resource constraint; and
generating the distributed operation strategy of the neural network model based on the found sub-strategy.

17. The electronic device of claim 16, wherein pre-constructed neural network patterns gradually increase from a last-level granularity to a top-level granularity, and
the instruction, when executed by the at least one processor, enables the at least one processor to execute matching the neural network pattern at at least one granularity level in the operator topology graph, by:
for the operator topology graph, performing following operations in order from the last-level granularity to the top-level granularity until a neural network pattern at the top-level granularity is matched:
determining a topology graph to be processed at a target granularity; and
matching a neural network pattern at the target granularity in the topology graph to be processed;
wherein, in a case of the target granularity is the last-level granularity, the topology graph to be processed is the operator topology graph; and
in a case of the target granularity is other granularity than the last-level granularity, the topology graph to be processed is constructed based on a neural network pattern matched at a previous granularity of the other granularity.

18. A non-transitory computer-readable storage medium storing a computer instruction thereon, wherein the computer instruction is used to cause a computer to execute:
parsing code of a neural network model to construct an operator topology graph corresponding to the neural network model;
generating a distributed operation strategy of the neural network model based on the operator topology graph and a preset resource constraint; and
modifying the code of the neural network model based on the distributed operation strategy to obtain target code; wherein the target code is used to operate the neural network model based on the distributed operation strategy on a computing device corresponding to the resource constraint.

19. The non-transitory computer-readable storage medium of claim 18, wherein the computer instruction is used to cause the computer to execute the parsing code of the neural network model to construct the operator topology graph corresponding to the neural network model, by:
parsing out a layer identifier of each neural network layer and a layer dependency relationship from the code of the neural network model;
determining an operator structure corresponding to each neural network layer based on the layer identifier of each neural network layer; and
constructing the operator topology graph corresponding to the neural network model based on the layer dependency relationship and the operator structure corresponding to each neural network layer.

20. The non-transitory computer-readable storage medium of claim 18, wherein the computer instruction is used to cause the computer to execute generating the distributed operation strategy of the neural network model based on the operator topology graph and the preset resource constraint, by:
matching a neural network pattern at at least one granularity level in the operator topology graph;
searching for a sub-strategy for implementing distributed operation corresponding to the neural network pattern at at least one granularity level under the resource constraint; and
generating the distributed operation strategy of the neural network model based on the found sub-strategy.
